(19) United States
(12) Patent Application Publication
(10) Pub. No.: US 2015/0376961 A1
(43) Pub. Date: Dec. 31, 2015

(54) Method for Prolonging a Wellbore Cable Life

(71) Applicant: Schlumberger Technology Corporation, Sugar Land, TX (US)

(72) Inventors: Serko Sarian, Houston, TX (US); Harold S. Bissonnette, Heber Springs, AR (US); Sashank Vasireddy, Stafford, TX (US)

(21) Appl. No.: 14/788,516

(22) Filed: Jun. 30, 2015

Related U.S. Application Data
(60) Provisional application No. 62/019,336, filed on Jun. 30, 2014.

(51) Int. Cl. E21B 19/00; B08B 3/04; E21B 17/20; B08B 1/02

(52) U.S. Cl. CPC E21B 19/00; B08B 1/02; B08B 3/041; E21B 17/20

(57) ABSTRACT

A method for prolonging a wellbore cable life that includes pulling a cable from a wellbore. The method can also include cleaning the cable as the cable is pulled out of the wellbore. The method can also include applying a fluid to the cable as the cable is pulled out of the wellbore.

### CROSS-REFERENCE TO RELATED APPLICATIONS

This application claims benefit of and priority to U.S. Provisional Application Ser. No. 62/019,336, filed on Jun. 30, 2014, and entitled “Methods and Apparatus for Coating a Cable.” The entirety of the foregoing application is incorporated herein by reference.

### FIELD OF THE DISCLOSURE

The disclosure generally relates to methods and apparatus for protecting a cable in real-time during conveyance of a cable into a wellbore, pulling out of hole, or combinations thereof.

### BACKGROUND

Cables are often exposed to harsh environments. The cable's useful life can be diminished by the harsh environments. Properly cleaning the cables and applying appropriate coatings can prevent the diminishment of the cable's useful life due to exposure to harsh environments.

### SUMMARY

An example method for prolonging a wellbore cable life includes pulling a cable from a wellbore. The method can also include cleaning the cable as the cable is pulled out of the wellbore. The method can also include applying a fluid to the cable as the cable is pulled out of the wellbore.

Another example method for prolonging a wellbore cable life includes pulling a cable from a wellbore after performing a wellbore operation. The method can also include passing the cable through a cable cleaner located proximate to a wellhead. The method can also include measuring the speed of a cable, and providing data on the cable speed of the cable to a pump controller in communication with a pump that is in fluid communication with an apparatus. The method can also include optimizing the flow rate of fluid to the apparatus to match the speed of the cable.

### BRIEF DESCRIPTION OF THE DRAWINGS

FIG. 1 depicts a schematic of a cable coating system according to one or more embodiments.

FIG. 2 depicts a schematic of a cable coating system according to one or more embodiments according to one or more embodiments.

FIG. 3 depicts a schematic of a cross section of a cable cleaner according to one or more embodiments.

FIG. 4 depicts a schematic of an assembled cable cleaner according to one or more embodiments.

FIG. 5 depicts a flow diagram of a method of prolonging a cable life by cleaning and applying a fluid to the cable in real-time during operations at a wellsite.

FIG. 6 depicts a method of prolonging the life of a cable in real-time at a wellsite.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

An example method for prolonging a wellbore cable life can include pulling a cable from a wellbore. The method can also include cleaning the cable as the cable is pulled out of the wellbore. The method can also include applying a fluid to the cable as the cable is pulled out of the wellbore, wherein the application rate of the fluid is adjusted based on the cable speed.

Another example method for prolonging a wellbore cable life includes pulling a cable from a wellbore after performing a wellbore operation. The method can also include passing the cable through a cable cleaner located proximate to a wellhead. The method can also include measuring the speed of a cable, and providing data on the cable speed of the cable to a pump controller in communication with a pump that is in fluid communication with an apparatus. The method can also include optimizing the flow rate of fluid to the apparatus to match the speed of the cable. Optimizing the flow rate of fluid to the apparatus to match the speed of the cable can include determining, based on the fluid specs, the amount of fluid that should be applied per foot of cable and adjusting the flow rate of fluid to the apparatus to ensure that the amount of fluid applied per foot of cable match the fluid specs. For example, if the cable is traveling at 30 ft/minute and the fluid spec says that 30 cubic feet of fluid should be applied to 1 foot of cable, the pump controller would adjust the pump flow rate so that fluid is provided to the apparatus at 30 cubic feet per minute. The spec can be inputted into the controller before deployment of the cable, before retrieval of the cable, or combinations thereof and stored in memory in communication with the pump controller, the pump controller can receive cable speed data from a monitoring device, calculate the flow rate based on the cable speed and the fluid spec, and adjust the pump to provide the required flow rate.

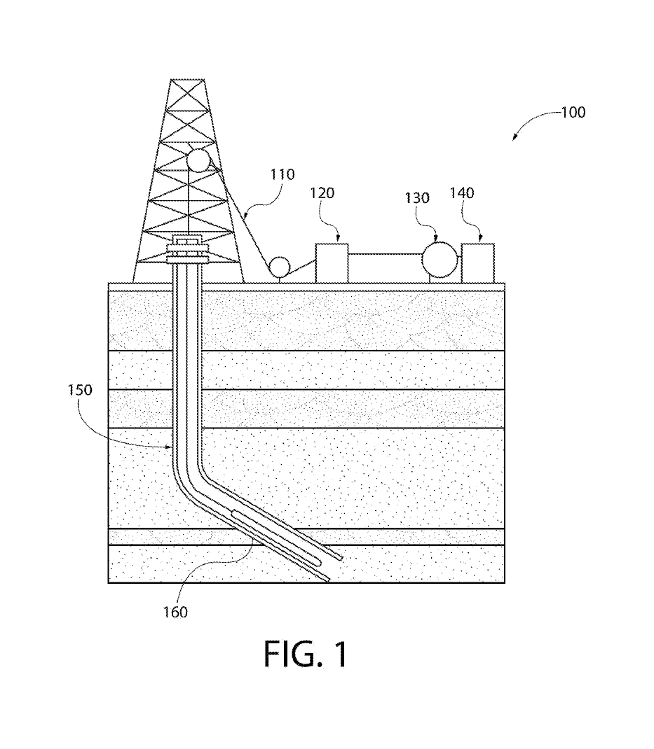

FIG. 1 depicts a schematic of a cable coating system according to one or more embodiments.

The system 100 includes a cable 110, an apparatus 120, and a spooling device 130. The cable 110 can be wireline, slickline, braided cable, coated cable, or combinations thereof. The spooling device 130 can be a winch or other device configured to spool cable. System 100 can be used to deploy cable into a wellbore, as depicted; however, the system 100 can also be used to deploy cable in many different applications.

The cable 110 is connected at one end with the spooling device 130. The spooling device 130 is controlled by a spooling device controller 140. The cable 110 is connected at a terminal end with a tool 160. The tool 160 can be a downhole tool. The tool 160 is depicted located in a wellbore 150. An apparatus 120 is located between the terminal end of the cable 110 and the spooling device 120. The cable 110 passes through the apparatus 120 as the cable is deployed and retrieved. The apparatus 120 can apply fluid to the cable as it passes therethrough as the cable is deployed, retrieved, or both. The apparatus 120 can be an automated applicator, such as those provided by Graco Automatic Lubrication systems, or other now know or future known applicators that have adjusted coating rates.

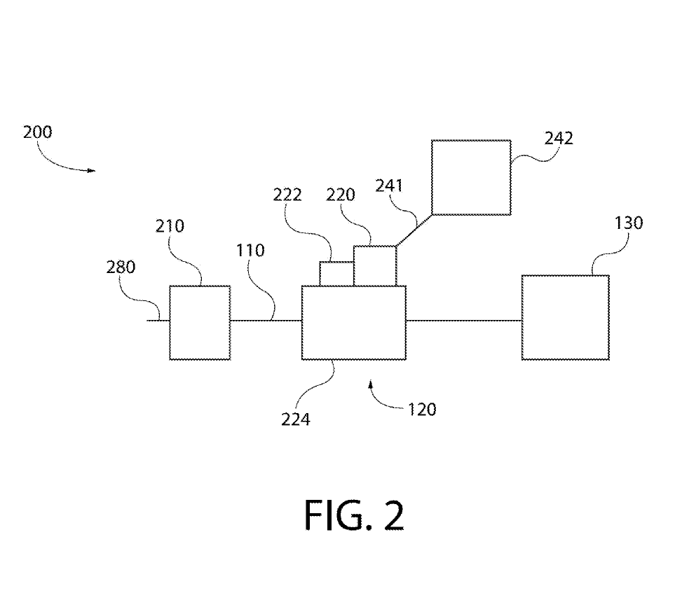

FIG. 2 depicts a schematic of a cable coating system according to one or more embodiments.

The system 200 includes the apparatus 120, the spooling device 130, a monitoring device 242, the cable 110, and a cable cleaner 210.

The apparatus 120 includes a body 224. The body 224 is in fluid communication with a pump 222. The pump 222 is controlled by a pump controller 220. The cable 110 can be connected with the spooling device 130 and have a terminal end 280. The terminal end 280 can be connected with appropriate equipment. The appropriate equipment can be a wireline intervention tool, pump, tractor, or other downhole equipment.

The pump controller 220 is in communication with a monitoring device 242 via communication path 241. The monitoring device 242 can be a data acquisition device that is in communication with one or more sensors, controllers, or the like. For example, the monitoring device 242 can be in communication with a controller of the spooling device 130, a device connected with the cable for determining the speed of the cable, a sensor, or controller on a tool or device connected with the cable, or combinations thereof. The monitoring device 242 can receive data on the speed of the cable 110 and communicate the speed of the cable 110 to the pump controller 220.

The pump controller 220 automatically adjusts the pump to provide a fluid flow rate that is desired for the detected cable speed. For example, a first fluid flow rate of 1 cubic centimeter per second may be desired for a cable speed of 1 foot per second and a second fluid flow rate of 2 cubic centimeters per second may be desired for a cable speed of 2 feet per second; therefore, if the monitoring device 242 relays to the pump controller 220 that the cable speed has decreased from 2 feet per second to 1 foot per second, the pump controller will automatically adjust the pump to provide a fluid flow rate of 1 cubic centimeter per second.

A cable cleaner 210 is located between the terminal end 280 and the apparatus 120. The cable cleaner 210 can clean the cable 110 as it is retrieved. In one or more embodiments, the cable cleaner can inject a fluid onto the cable as the cable is deployed into the wellbore. In another embodiment, the apparatus 120 can coat the cable with a first fluid as the cable is pulled out of hole and with a second fluid when the cable is conveyed into the wellbore.

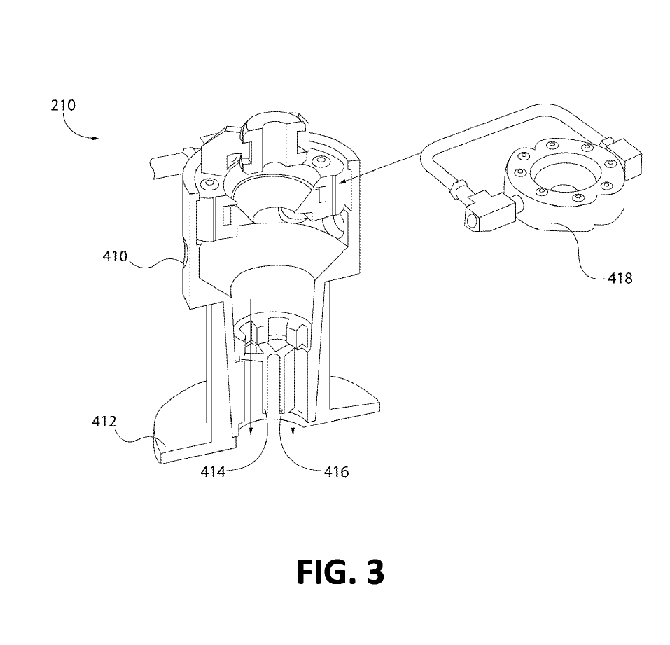

FIG. 3 depicts a schematic of a cross section of a cable cleaner according to one or more embodiments.

The cable cleaner 210 includes a housing 410, a base 412, brushes 414, and an air wiper 418. The housing 410 is configured to house the air wiper 418 and the brushes 414. The air wiper 418 can be any commercially available air wiper. The air wiper 418 and brushes 414 can remove debris 414 from the cable and the cable passes through the cable cleaner 210.

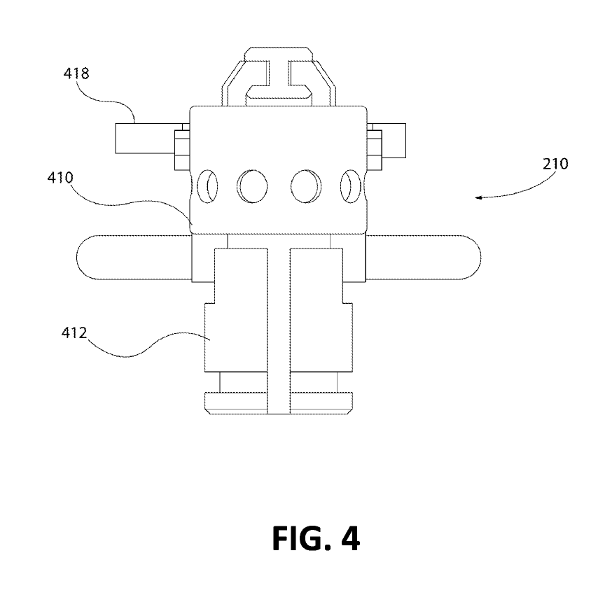

FIG. 4 depicts a schematic of an assembled cable cleaner according to one or more embodiments.

The housing 410 is a split housing. The portions of the housing 410 are held in place by the base 412. The air wiper 418 is held in place by the housing 410 when the portions of the housing 410 are held together by the base 412. The housing 410 allows for a cable to be released if the cable gets stuck in the cable cleaner 210. For example, the cable will lift the housing 410 out of the base 412, and the portions of the housing 410 will be allowed to separate from one another.

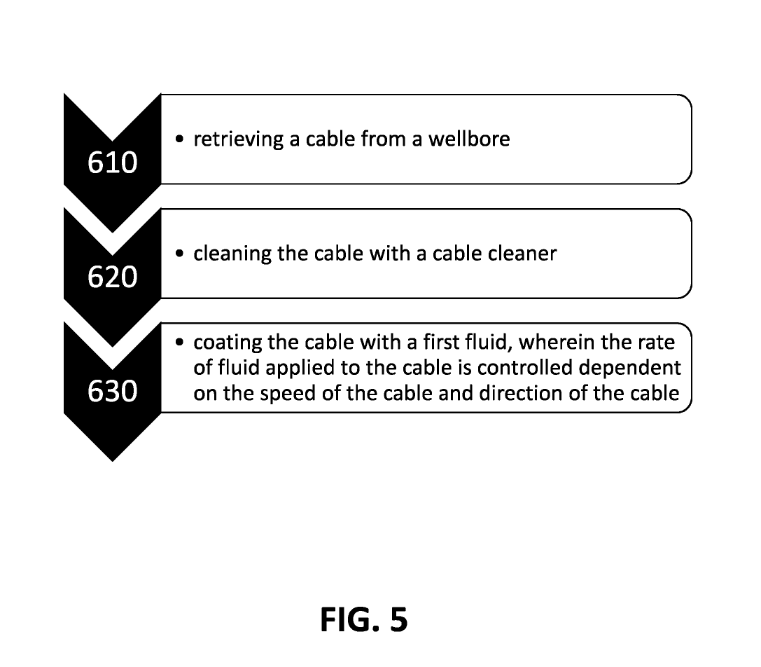

FIG. 5 depicts a flow diagram of a method of prolonging a cable life by cleaning and applying a fluid to the cable in real-time during operations at a wellsite.

The method in includes retrieving a cable from a wellbore, Box 610. The method also includes cleaning the cable with a cable cleaner, Box 620. The cable cleaner can be connected proximate to a wellhead. The cable cleaner can use both mechanical and pneumatic pressure to clean the cable as it is retrieved. The method also include coating the cable with a first fluid, wherein the rate of fluid applied to the cable is controlled dependent on the speed of the cable and direction of the cable, Box 630.

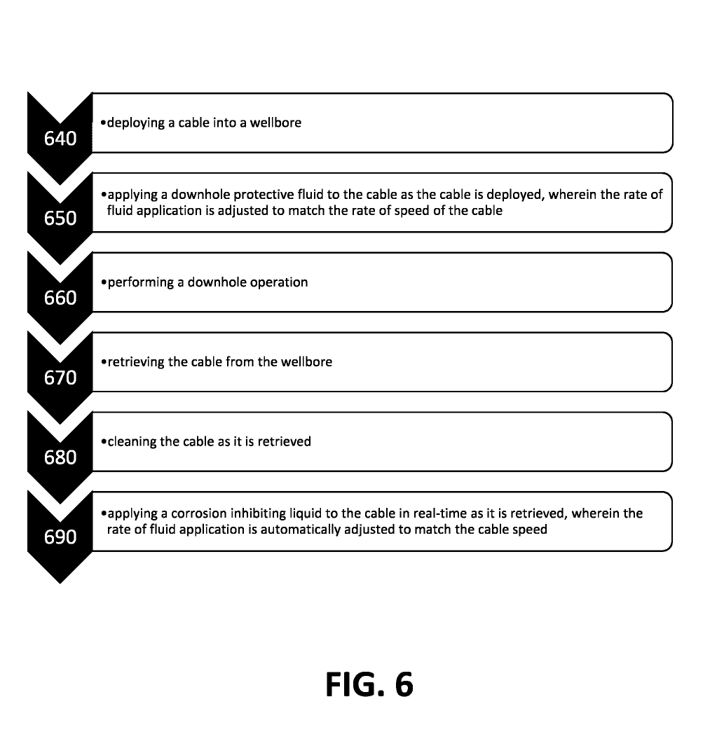

FIG. 6 depicts a method of prolonging the life of a cable in real-time at a wellsite. The method includes deploying a cable into a wellbore, Box 640. The method also includes applying a downhole protective fluid to the cable as the cable is deployed, wherein the rate of fluid application is adjusted to match the rate of speed of the cable, Box 650. The method can also include performing a downhole operation, Box 660. The method can also include retrieving the cable from the wellbore, Box 670. The method can also include cleaning the cable as it is retrieved, Box 680. The method can also include applying a corrosion inhibiting liquid to the cable in real-time as it is retrieved, wherein the rate of fluid application is automatically adjusted to match the cable speed, Box 690.

Although example assemblies, methods, systems have been described herein, the scope of coverage of this patent is not limited thereto. On the contrary, this patent covers every method, nozzle assembly, and article of manufacture fairly falling within the scope of the appended claims either literally or under the doctrine of equivalents.

What is claimed is:

1. A method for prolonging a wellbore cable life, wherein the method comprises:
pulling a cable from a wellbore;
cleaning the cable as the cable is pulled out of the wellbore, wherein the cleaning is done with a cable cleaner that uses both mechanical and pneumatic force to clean the cable; and
applying a fluid to the cable as the cable is pulled out of the wellbore.

2. The method of claim 1, further comprising applying an additional fluid to the cable as the cable is deployed into a wellbore, wherein the application rate of the additional fluid is adjusted based on the cable speed.

3. The method of claim 1, wherein the cable cleaner is proximate the wellhead.

4. The method of claim 1, wherein the fluid is applied by an apparatus remote from the cable cleaner.

5. The method of claim 1, wherein the cable cleaner is configured to release upon the cable sticking therein.

6. A method for prolonging a wellbore cable life, wherein the method comprises:
pulling a cable from a wellbore after performing a wellbore operation;
passing the cable through a cable cleaner located proximate to a wellhead;
measuring the speed of a cable;
providing data on the cable speed of the cable to a pump controller in communication with a pump that is in fluid communication with an apparatus; and
optimizing the flow rate of fluid to the apparatus to match the speed of the cable.

7. The method of claim 6, wherein the cable cleaner is proximate the wellhead.

8. The method of claim 6, wherein the fluid is applied by an apparatus remote from the cable cleaner.

9. The method of claim 6, wherein the cable cleaner is configured to release upon the cable sticking therein.

10. The method of claim 6, wherein the cable cleaner uses mechanical and pneumatic forces to clean the cable.

11. A method for prolonging a wellbore cable life, wherein the method comprises:
running a cable into a wellbore to performing a wellbore operation; and
coating the cable with a fluid before entering the wellbore.

12. The method of claim 11, further comprising performing the wellbore operation and retrieving the cable from the wellbore.

13. The method of claim 11, further comprising cleaning the cable with a cable cleaner proximate the wellhead.

14. The method of claim 13, further comprising applying an additional fluid to the cable.

15. The method of claim 14, wherein the fluid and the additional fluid are applied to the cable using the same apparatus.

16. The method of claim 14, wherein the fluid is applied proximate to the wellhead and the additional fluid is applied distal from the wellhead.
